(19) United States
(12) Patent Application Publication
(10) Pub. No.: US 2024/0278758 A1
(43) Pub. Date: Aug. 22, 2024

(54) METHOD OF AVOIDING THE HYDRAULIC FALLBACK LEVEL IN A BRAKE SYSTEM OF A MOTOR VEHICLE

(71) Applicant: Continental Automotive Technologies GmbH, Hannover (DE)

(72) Inventors: Aleksandar Stanojkovski, Kleinostheim (DE); Felix Alexander Fertig, Frankfurt am Main (DE); Thorsten Wickenhöfer, Hofheim (DE)

(73) Assignee: Continental Automotive Technologies GmbH, Hannover (DE)

(21) Appl. No.: 18/571,422

(22) PCT Filed: Jun. 2, 2022
(86) PCT No.: PCT/DE2022/200108

§ 371 Date: Dec. 18, 2023

(30) Foreign Application Priority Data
Jun. 17, 2021 (DE) 10 2021 206 232.6

(51) Int. Cl. B60T 13/66; B60T 13/68; B60T 17/22

(52) U.S. Cl. CPC B60T 13/662; B60T 13/686; B60T 17/226; B60T 2201/06

(57) ABSTRACT

A hydraulic brake system of a motor vehicle includes a linear actuator as a driver-independent pressure provision device and a hydraulic valve arrangement between the linear actuator and wheel brakes. In the case of a reduced availability of the linear actuator, a holding mode is carried out, in which the hydraulic pressure in the wheel brakes is shut in with the valve arrangement and a power output of the linear actuator is reduced, the system pressure gradient in the holding mode is measured, and a transition from the holding mode into an alternative mode is carried out based on the system pressure gradient.

### CROSS-REFERENCE TO RELATED APPLICATIONS

The present application is a 35 U.S.C. § 371 National Stage patent application of International patent application No. PCT/DE2022/200108, filed on Jun. 2, 2022, which claims priority to German patent application No. 10 2021 206 232.6, filed on Jun. 17, 2021.

### TECHNICAL FIELD

The technical field relates to a method for regulating a hydraulic brake system of a motor vehicle having a linear actuator as driver-independent pressure provision device, and a hydraulic valve arrangement between the linear actuator and wheel brakes of the hydraulic brake system.

### BACKGROUND

By way of the driver-independent pressure build-up with a linear actuator, it is possible for a multiplicity of complex regulating operations to be implemented which improve the comfort and the reliability of a brake system. A motor of the linear actuator has mechanical and, in particular thermal, limits, however, which are opposed to continuous loading. In the case of a determined overload and an associated restricted availability, the linear actuator therefore has to be degraded as far as a complete shutdown, in order to prevent irreversible damage. To this end, the brake system is switched into a hydraulic fallback level, in which the driver has to apply a brake force solely by means of muscle power.

It is therefore desirable to avoid a premature switchover into the hydraulic fallback level.

### SUMMARY

The disclosure presents a method for regulating a hydraulic brake system of a motor vehicle. The hydraulic brake system includes a linear actuator as a driver-independent pressure provision device and a hydraulic valve arrangement between the linear actuator and wheel brakes of the hydraulic brake system. In the case of a reduced availability of the linear actuator, a holding mode is carried out, in which the hydraulic pressure in the wheel brakes is shut in by means of the valve arrangement and a power output of the linear actuator is reduced, in particular to zero. Here, the system pressure gradient, that is to say the hydraulic pressure in a region which is connected to the wheel brakes and therefore indicates information about the brake force, in the holding mode is measured, and a transition from the holding mode into an alternative mode is carried out based on the system pressure gradient.

It can be provided as start condition to the holding mode, for example, that the linear actuator displays a reduced availability, for example a thermal overload, the vehicle is at a standstill, and a determined driver brake request corresponds to a pressure requirement of greater than from 5 to 10 bar. It can be provided as termination condition for the holding mode that the vehicle is rolling, that is to say has a speed of greater than zero, the driver request decreases by a predefined absolute or percentage amount, or the driver actuates the brake pedal with more than 500 N.

The transition into the alternative mode avoids a situation where the brake system has to be degraded directly into a complete hydraulic fallback level.

In one embodiment, a determination is made as to how far the system pressure has dropped in the holding mode, a transition into the alternative mode being carried out if the system pressure has dropped below a threshold value. The threshold value can be selected, in particular, as a percentage of the original value at the beginning of the holding mode. As an alternative, the system pressure gradient can also be analysed in some other way; for example, a check can be made as to how rapidly the system pressure drops.

In one embodiment, the threshold value is set based on the roadway gradient. Here, only smaller deviations from the original value are permitted on a steep slope in comparison with on the level. For example, two threshold values can be provided. If the vehicle inclination is smaller than an inclination limit and the measured system pressure during the holding mode drops by a first percentage threshold value, safeguarding of the standstill is then transferred to the alternative mode. If, in contrast, the vehicle inclination is greater than or equal to the inclination limit a, safeguarding of the standstill is already transferred to the alternative mode when the measured system pressure during the holding mode drops by a second percentage threshold value which is smaller than the first threshold value.

In a further embodiment, the reduced availability of the linear actuator is detected if a temperature which is assigned to the linear actuator exceeds a threshold value. The temperature can be determined at the linear actuator with a temperature sensor or can be calculated from variables such as the electrical resistance of motor coils. As an alternative or in addition, the temperature can be determined with temperature models.

In the case of the temperature models, the starting point is a start temperature of components. This start temperature can be determined, for example, by way of a sensed ambient temperature. Subsequently, the electrical energy input of the motor, that is to say the energization magnitude and energization duration, is added to the calculation. This energy input is added to the calculation of the start temperature of the components, and the new actual temperature is determined in this way.

In a further embodiment, a replenishing mode is carried out based on the system pressure gradient and the availability of the linear actuator, in the case of which replenishing mode the shut-in pressure is increased by way of the linear actuator and subsequently a switchover is carried out again into the holding mode. The replenishing mode can be carried out, in particular, as soon as the system pressure undershoots a second threshold value which lies above the first threshold value. At the same time, the linear actuator has to make at least the brief replenishing possible. To this end, for example, a second temperature threshold value can be provided. As a result of the replenishing, the overall time, for which a brake pressure can be maintained, can be increased greatly, since the linear actuator is electrically actuated in each case only briefly for a pressure build-up and can in each case cool off again during pressure holding.

In a further embodiment, the holding mode is carried out when the motor vehicle is at a standstill. The safety requirements are lower at a standstill, with the result that the maintenance of a pressure is sufficient for the operation of the brake system.

In a further embodiment the alternative mode is especially not the hydraulic fallback level, in which solely the driver can exert a brake force.

In a further embodiment, the alternative mode is a parking brake mode, in the case of which an electromechanical parking brake of the motor vehicle is applied and the hydraulic brake system is deactivated, as a result of which the vehicle is held by way of the parking brake. Therefore, in addition to the linear actuator, the electrohydraulic valves can also be set into a currentless state, in which cooling becomes possible. The hydraulic brake system can also be switched off only partially as required.

In a further embodiment, the alternative mode is a cooperative mode, in the case of which an additional hydraulic pressure provision device is actuated in order to increase the shut-in pressure, and subsequently a switchover is carried out again into the holding mode. In this way, the linear actuator can be relieved by way of the use of the further pressure provision device.

In a further embodiment, the alternative mode is a half mode, in the case of which the valve arrangement is actuated in order to connect the wheel brakes of a first axle in an open-flow manner to a brake master cylinder which can be actuated by way of the driver and in order to shut in the hydraulic pressure of the wheel brakes of a second axle. In this way, a separation of the two circuits by way of a circuit isolating valve takes place.

In one embodiment, in the case of the switchover into the half mode, the pressure of the wheel brakes is matched to the pressure of the brake master cylinder before the valve arrangement establishes an open-flow connection. To this end, for example, the outlet valves can be opened briefly. It is avoided in this way that pressure pulses are transmitted to the brake pedal and therefore to the driver.

In a further embodiment, at the beginning of the holding mode, a pressure which is greater than the requested pressure is built up by way of a linear actuator, and the greater pressure is shut in. Therefore, a certain pressure drop is already calculated over time, which pressure drop can be determined, for example, via known leakage values of the individual valves. As a result of the elevated original value at the beginning of the holding mode, the threshold value can be selected to be lower in percentage terms, and a minimum pressure for holding the vehicle at a standstill can be maintained for a longer time.

Moreover, of the disclosure provides a hydraulic brake system for a motor vehicle having a linear actuator as driver-independent pressure provision device, a hydraulic valve arrangement between the linear actuator and wheel brakes of the hydraulic brake system, and a control device which is configured to carry out an above method.

Further features, advantages and possible applications also result from the following description of exemplary embodiments and the drawings. All of the features described and/or pictorially depicted belong to the subject matter of the disclosure both individually and in any combination, also independently of their summarization in the claims or the back-references thereof.

### BRIEF DESCRIPTION OF THE DRAWINGS

FIG. 1 diagrammatically shows a brake system according to a first embodiment,

FIG. 2 diagrammatically shows a brake system according to a second embodiment, and

FIG. 3 shows a chronological sequence of the transfer into the holding mode.

### DETAILED DESCRIPTION

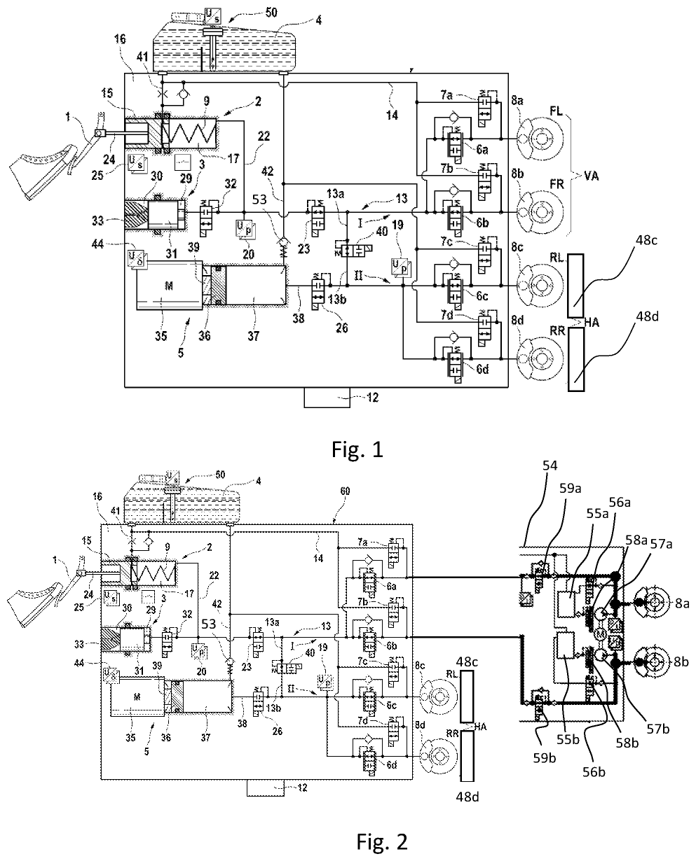

The brake system shown in FIG. 1 for a motor vehicle includes four hydraulically actuable wheel brakes 8a-8d. The brake system includes a brake master cylinder 2 which can be actuated with an actuating or brake pedal 1, a travel simulator or a simulation device 3 which interacts with the brake master cylinder 2, a pressure medium reservoir 4 which is under atmospheric pressure, an electrically controllable pressure provision device 5, and a valve arrangement comprising wheel-individual brake pressure modulation valves which, according to the example, are configured as inlet valves 6a-6d and outlet valves 7a-7d. Furthermore, the brake system includes at least an electronic control and regulating unit 12 for actuating the electrically actuable components of the brake system.

According to the example, the wheel brake 8a is assigned to the left front wheel (FL), the wheel brake 8b is assigned to the right front wheel (FR), the wheel brake 8c is assigned to the left rear wheel (RL), and the wheel brake 8d is assigned to the right rear wheel (RR).

In a housing 16, the brake master cylinder 2 has a brake master cylinder piston 15 which delimits a hydraulic pressure chamber 17, and is a single-circuit brake master cylinder 2. The pressure chamber 17 receives a restoring spring 9 which, with the master brake cylinder 2 unactuated, positions the piston 15 in a starting position. The pressure chamber 17 is firstly connected to the pressure medium reservoir 4 via radial bores configured in the piston 15 and a corresponding pressure equalizing line 41, it being possible for these bores and line to be shut off by way of a relative movement of the piston 15 in the housing 16. Secondly, the pressure chamber 17 is connected with a hydraulic line section (also referred to as first feed line) 22 to a brake supply line 13, to which the inlet ports of the inlet valves 6a-6d are connected. The pressure chamber 17 of the brake master cylinder 2 is thus connected to all the inlet valves 6a-6d.

According to the example, no hydraulic valve, in particular no electrically or hydraulically actuatable valve and no check valve, is arranged in the pressure equalizing line 41 or in the connection between the pressure chamber 17 and the pressure medium reservoir 4.

Alternatively, a normally open diagnostic valve, preferably a connection in parallel of a normally open diagnostic valve with a check valve which closes in the direction of the pressure medium reservoir 4, can be contained in the pressure equalizing line 41 or between the brake master cylinder 2 and the pressure medium reservoir 4.

Moreover, the valve arrangement may include further hydraulic valves. An isolating valve 23 is arranged between the feed line 22 connected to the pressure chamber 17 and the brake supply line 13, or the pressure chamber 17 is connected to the brake supply line 13 via the first feed line 22 having an isolating valve 23. The isolating valve 23 is configured as an electrically actuable, preferably normally open (NO), 2/2-way valve. The isolating valve 23 allows the hydraulic connection between the pressure chamber 17 and the brake supply line 13 to be shut off.

A piston rod 24 couples the pivoting movement of the brake pedal 1 as a consequence of a pedal actuation to the translational movement of the brake master cylinder piston 15, the actuation travel of which is detected by a displacement sensor 25 of preferably redundant configuration. In this way, the corresponding piston travel signal is a measure of the brake pedal actuation angle. It represents a braking demand of a vehicle driver.

A pressure sensor 20 connected to the first feed line 22 detects the pressure built up in the pressure chamber 17 as a result of a displacement of the piston 15. This pressure value can also be evaluated to characterize or determine the braking demand of the vehicle driver. As an alternative to a pressure sensor 20, use can also be made of a force sensor 20 for determining the braking demand of the vehicle driver.

According to the example, the simulation device 3 is of hydraulic configuration and is coupled hydraulically to the brake master cylinder 2. The simulation device 3 has, for example, substantially a simulator chamber 29, a simulator rear chamber 30 and a simulator piston 31 which separates the two chambers 29, 30 from one another. The simulator piston 31 is supported on a housing by way of an elastic element 33 (for example, simulator spring) arranged in the simulator rear chamber 30 (which is dry according to the example). According to the example, the hydraulic simulator chamber 29 is connected to the pressure chamber 17 of the brake master cylinder 2 with an electrically actuable, normally closed simulator enable valve 32.

Per hydraulically actuable wheel brake 8a-8d, the brake assembly or the brake system comprises an inlet valve 6a-6d and an outlet valve 7a-7d which are hydraulically connected together in pairs via center ports and are connected to the wheel brake 8a-8d. A check valve, which is not designated in greater detail and opens toward the brake supply line 13, is connected in parallel in each case to the inlet valves 6a-6d. The outlet ports of the outlet valves 7a-7d are connected to the pressure medium reservoir 4 via a common return line 14.

The electrically controllable pressure provision device 5 is configured as a hydraulic cylinder/piston arrangement (or a single-circuit, electrohydraulic actuator) or a linear actuator, the piston 36 of which can be actuated by a diagrammatically indicated electric motor 35 with the likewise diagrammatically shown rotational/translational gear mechanism 39 connected in between. The piston 36 delimits the single pressure space 37 of the pressure provision device 5. A merely schematically indicated rotor position sensor which serves to detect the rotor position of the electric motor 35 is denoted by the designation 44.

A line section (also referred to as second feed line) 38 is connected to the pressure space 37 of the electrically controllable pressure provision device 5. The feed line 38 is connected to the brake supply line 13 via an electrically actuable, preferably normally closed adding valve 26 as part of the valve arrangement. The adding valve 26 allows the hydraulic connection between the pressure space 37 of the electrically controllable pressure provision device 5 and the brake supply line 13 (and thus the inlet ports of the inlet valves 6a-6d) to be opened and shut off in a controlled manner.

The actuator pressure produced by the action of force of the piston 36 on the pressure medium enclosed in the pressure space 37 is fed into the second feed line 38. In a “brake-by-wire” operating type, in particular in a fault-free state of the brake system, the feed line 38 is connected via the adding valve 26 to the brake supply line 13. In this way there occurs, during normal braking, a wheel brake pressure build-up and pressure reduction for all the wheel brakes 8a-8d as a result of the forward and backward movement of the piston 36.

In the case of a pressure reduction by backward movement of the piston 36, the pressure medium previously displaced from the pressure space 37 of the pressure provision device 5 into the wheel brakes 8a-8d flows back again into the pressure space 37 in the same way.

As an alternative, wheel brake pressures which are different in a wheel-individual manner can be set simply by means of the inlet and outlet valves 6a-6d, 7a-7d. In the case of a corresponding pressure reduction, the pressure medium fraction discharged via the outlet valves 7a-7d flows via the return line 14 into the pressure medium reservoir 4.

Replenishing of pressure medium into the pressure space 37 is possible by way of the piston 36 moving back in the case of a closed adding valve 26, by it being possible for pressure medium to flow out of the container 4 via the line 42 with a check valve 53 which opens in the flow direction toward the actuator 5 into the actuator pressure space or pressure space 37. According to the example, the pressure space 37 is additionally connected, in an unactuated state of the piston 36, to the pressure medium reservoir 4 via one or more snifting holes. This connection between the pressure space 37 and the pressure medium reservoir 4 is disconnected upon a (sufficient) actuation of the piston 36 in the actuating direction 27.

An electrically actuable, normally open circuit isolating valve 40, by way of which the brake system is split into two hydraulic part circuits, is arranged in the brake supply line 13. The brake supply line 13 is split into a first line section 13a which is connected (via the isolating valve 23) to the brake master cylinder 2, and a second line section 13b in the second hydraulic part circuit which is connected (via the adding valve 26) to the pressure provision device 5. The first line section 13a is connected to the inlet valves 6a, 6b of the wheel brakes 8a, 8b, and the second line section 13b is connected to the inlet valves 6c, 6d of the wheel brakes 8c, 8d.

With the circuit isolating valve 40 opened, the brake system is of single-circuit design. By way of closure of the circuit isolating valve 40, the brake system can be divided or split into two hydraulic part circuits, brake circuits I and II, in particular in a manner which is controlled according to the situation. Here, in the first brake circuit I, the brake master cylinder 2 is connected (via the isolating valve 23) to only the inlet valves 6a, 6b of the wheel brakes 8a, 8b of the front axle VA, and, in the second brake circuit II, the pressure provision device 5 is connected (with the adding valve 26 opened) to only the wheel brakes 8c and 8d of the rear axle HA.

In the case of an open circuit isolating valve 40, the inlet ports of all the inlet valves 6a-6d can be supplied by means of the brake supply line 13 with a pressure which, in a first operating type (for example, “brake-by-wire” operating type), corresponds to the brake pressure which is provided by the pressure provision device 5. In a second operating type (for example, in a currentless fallback operating type), the brake supply line 13 can be loaded with the pressure of the pressure chamber 17 of the brake master cylinder 2.

The brake system advantageously includes a level measuring device 50 for determining a pressure medium level in the pressure medium reservoir 4.

According to the example, the hydraulic components, namely the brake master cylinder 2, the simulation device 3, the pressure provision device 5, the valve arrangement with the hydraulic valves 6a-6d, 7a-7d, 23, 26, 40 and 32, and the hydraulic connections including the brake supply line 13, are together arranged in a hydraulic control and regulating unit 60 (HCU). The hydraulic control and regulating unit 60 is assigned the electronic control and regulating unit (ECU) 12. Hydraulic and electronic control and regulating units 60, 12 are preferably configured as one unit (HECU).

The brake system includes a pressure sensor 19 or system pressure sensor for detecting the pressure which is provided by the pressure provision device 5. Here, the pressure sensor 19 is arranged downstream of the adding valve 26, as viewed from the pressure chamber 37 of the pressure provision device 5.

In addition to the hydraulic actuation, the two rear wheel brakes 8c, 8d are each equipped with an integrated parking brake 48c, 48d which are configured as electromechanical parking brakes.

In a normal operating mode, the isolating valve 23 is closed and the adding valve 26 and the circuit isolating valve 40 are open, with the result that the hydraulic pressure in all the wheel brakes 8a to 8d is set by way of the linear actuator 5. If, at a standstill of the motor vehicle, a brake pressure is then maintained for a relatively long-time duration, the linear actuator has to continuously hold a counterforce to the hydraulic pressure, to which end it is operated by an electrical power input which is different than zero. This can lead to overheating of the linear actuator 5. If exceeding of a temperature threshold value is determined, a changeover is carried out according to the invention into the holding mode.

FIG. 2 then shows a further embodiment of a brake system. The connection to the front wheel brakes 8a, 8b is routed through a further brake unit 54 with in each case one switchover valve 59a, 59b which is open in normal operation. For redundancy reasons, the further brake unit comprises a further pressure loading device 57 which is configured as two hydraulic pumps 57a, 57b with a common motor. The hydraulic pumps 57a, 57b are connected on the suction side via in each case one normally closed pump isolating valve 58a, 58b to an associated low-pressure accumulator 55a, 55b which in turn has a connection to the brake fluid reservoir 4. Moreover, the low-pressure accumulators 55a, 55b are connected by way of a further valve 56a, 56b in each case to the associated wheel brake 8a, 8b.

The actuation of the hydraulic pump 57 and the linear actuator 5 can take place by way of two separate control units.

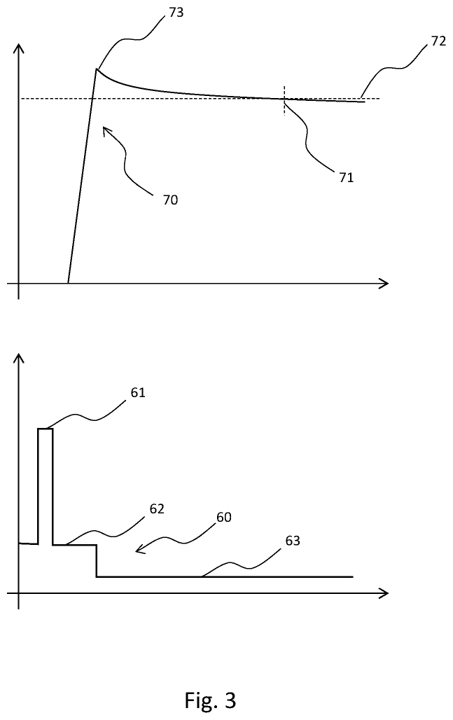

FIG. 3 shows a corresponding sequence with the system pressure 70 and the valve flow 60 of the adding valve 26. The valve flow 60 of the adding valve 26 is increased briefly to the opening flow 61, as a result of which the adding valve 26 opens. Afterward, the valve flow 60 is reduced to a holding flow 62 which holds the adding valve 26 open. While the adding valve 26 is open, a hydraulic pressure is built up by way of the linear actuator 5 and the system pressure 70 rises correspondingly.

In order to switch over into the holding mode, the adding valve 26 is then closed, as a result of which the hydraulic pressure is shut in in the wheel brakes 8a to 8d. To this end, the valve flow 60 of the adding valve 26 is reduced from the holding flow 62 to a closing flow 63. The electric current of the linear actuator 5 can be correspondingly switched off, with the result that the linear actuator can cool down. As shown in FIG. 3, the shut-in hydraulic pressure does not remain in an unchanged manner at the initial level, however, since all the hydraulic units, in particular the hydraulic valves of the valve arrangement, have a certain leakage flow.

According to one embodiment, the system pressure 70 is therefore monitored. At a time 71, the system pressure 70 drops below a threshold value 73 which is set at 90% of the original value 74 at the transition into the holding mode. Accordingly, a changeover into an alternative mode is carried out according to the invention.

In a first embodiment, switching is carried out into a parking brake mode as alternative mode. To this end, the electromechanical parking brakes 48c, 48d are applied, as a result of which the vehicle is held at a standstill. The hydraulic brake system can therefore be switched off or at least switched over in such a way that all the components can cool down, in order to be fully ready for use again at a later time.

In a second embodiment, switching is carried out into a cooperative mode as alternative mode. This is possible in the case of the brake system of FIG. 2 which, in addition to the linear actuator 5, also has a further pressure provision device 57. Here, the electric pumps 57a and 57b are actuated to increase the brake pressure in the wheel brakes 8a and 8b. As soon as a target pressure is reached, the pressure can once again be shut in. The cooperative mode can also be combined with the parking brake mode, by the electromechanical parking brakes 48c, 48d being activated at the same time on the rear axle.

In a third embodiment, switching is carried out into the half mode as alternative mode. Here, a circuit isolating valve 40 is closed, in order to divide the brake system into two-part circuits. The wheel brakes 8c and 8d of the rear axle then remain in a state, in which the hydraulic pressure is shut in. At the front axle, the wheel pressure of the wheel brakes 8a and 8b is adapted by way of brief opening of the outlet valves to the hydraulic pressure in the brake master cylinder 2. As soon as pressure equalization substantially prevails, the isolating valve 23 is opened, as a result of which the brake master cylinder 2 is connected to the wheel brakes 8a, 8b in an open-flow manner. In this way, the driver gains direct control over the front wheel brakes. Should the brake force not be sufficient to hold the vehicle at a standstill, the driver can increasingly depress the brake pedal in order to increase the brake force.

The use according to the alternative modes therefore prevents it being necessary for the brake system to switch directly into a hydraulic fallback level, in which only the driver still has to build up the required brake pressure via the brake master cylinder.

1-13. (canceled)

14. A method for regulating a hydraulic brake system of a motor vehicle having a linear actuator as a driver-independent pressure provision device, and a hydraulic valve arrangement disposed between the linear actuator and wheel brakes of the hydraulic brake system, the method comprising:
carrying out a holding mode in response to a reduced availability of the linear actuator, wherein the hydraulic pressure in the wheel brakes is shut in utilizing the valve arrangement and a power output of the linear actuator is reduced;
measuring the system pressure gradient in the holding mode; and
carrying out a transition from the holding mode into an alternative mode based on the system pressure gradient.

15. The method as set forth in claim 14, further comprising:
determining how far the system pressure has dropped in the holding mode; and
wherein the carrying out the transition from the holding mode into the alternative mode is further defined as carrying out the transition from the holding mode into the alternative mode in response to the system pressure dropping below a threshold value.

16. The method as set forth in claim 15, wherein the threshold value is set based on a roadway gradient.

17. The method as set forth in claim 14, wherein the reduced availability of the linear actuator is detected if a temperature which is assigned to the linear actuator exceeds a threshold value.

18. The method as set forth in claim 14, further comprising carrying out a replenishing mode based on the system pressure gradient and the availability of the linear actuator, wherein in the replenishing mode the shut-in pressure is increased by way of the linear actuator and subsequently a switchover is carried out again into the holding mode.

19. The method as set forth in claim 14, wherein the holding mode is carried out when the motor vehicle is at a standstill.

20. The method as set forth in claim 14, wherein the alternative mode is not the hydraulic fallback level.

21. The method as set forth in claim 14, wherein the alternative mode is a parking brake mode, in the case of which an electromechanical parking brake of the motor vehicle is applied and the hydraulic brake system is deactivated, as a result of which the vehicle is held by way of the parking brake.

22. The method as set forth in claim 14, wherein the alternative mode is a cooperative mode, in which an additional hydraulic pressure provision device is actuated in order to increase the shut-in pressure, and subsequently a switchover is carried out again into the holding mode.

23. The method as set forth in claim 14, wherein the alternative mode is a half mode, in which the valve arrangement is actuated in order to connect the wheel brakes of a first axle in an open-flow manner to a brake master cylinder which can be actuated by way of the driver and in order to shut in the hydraulic pressure of the wheel brakes of a second axle.

24. The method as set forth in claim 23, wherein, in the case of the switchover into the half mode, the pressure of the wheel brakes is matched to the pressure of the brake master cylinder before the valve arrangement establishes an open-flow connection.

25. The method as set forth in claim 14, wherein at the beginning of the holding mode, a pressure which is greater than the requested pressure is built up by way of a linear actuator, and the greater pressure is shut in.

26. A hydraulic brake system for a motor vehicle comprising:
a linear actuator as a driver-independent pressure provision device;
a hydraulic valve arrangement disposed between the linear actuator and wheel brakes of the vehicle; and
a control device configured to
carry out a holding mode in response to a reduced availability of the linear actuator, wherein the hydraulic pressure in the wheel brakes is shut in utilizing the valve arrangement and a power output of the linear actuator is reduced,
measure the system pressure gradient in the holding mode, and
carry out a transition from the holding mode into an alternative mode based on the system pressure gradient.
